(19) United States
(12) Patent Application Publication
(10) Pub. No.: US 2026/0365424 A1
(43) Pub. Date: Nov. 19, 2026

(54) AUTONOMOUS VEHICLE FOR ARTICLE STORAGE AND RETRIEVAL SYSTEM WITH A DEFLECTOR

(71) Applicant: EXOTEC PRODUCT FRANCE, Croix (FR)

(72) Inventors: Loïc Lepillier, Wattrelos (FR); Dimitri De Tonnac, Lezennes (FR)

(21) Appl. No.: 19/135,358

(22) PCT Filed: Dec. 8, 2023
(86) PCT No.: PCT/EP2023/084864

§ 371 Date: Jun. 3, 2025

(30) Foreign Application Priority Data
Dec. 9, 2022 (FR) FR2213072

(51) Int. Cl. B65G 1/04; B66F 9/065; B66F 9/075; B66F 9/18

(52) U.S. Cl. CPC B65G 1/0492; B66F 9/065; B66F 9/07572; B66F 9/18

(57) ABSTRACT

An autonomous vehicle (30) for an item storage and retrieval system (ASRS) (10) is proposed, the autonomous vehicle (30) being configured to move about in a storage area (12) in order to collect a receptacle (22a) among a plurality of receptacles (22) stored in the storage area (12), each receptacle (22) being arranged inside a cell (20) of the storage area (12), the cells (20) being distributed along two horizontal directions (X1, X2) and in a vertical direction (Z), the autonomous vehicle (30) comprising: a chassis (36); rolling means (38) adapted to move the chassis (36) in the two horizontal directions (X1, X2); climbing means (46) adapted to move the chassis (36) in the vertical direction (Z); gripping means (54) capable of gripping the receptacle (22a); at least one deflector (62) mounted laterally on the chassis (36), the deflector (62) having an external guide surface (64,66) that is inclined relative to the vertical direction (Z) and is configured to push the receptacles (22) towards a back (28) of the cells (20) when the chassis (36) is moved in the vertical direction (Z).

### TECHNICAL FIELD

This disclosure relates to the field of automated storage and retrieval systems (ASRS) in warehouses.

### PRIOR ART

Automated storage and retrieval systems (ASRS) are commonly equipped with storage racks and with a fleet of autonomous vehicles, or AGVs (Automated Guided Vehicles). One example is given in document US 2020/0172332 A1.

Storage racks are, in particular, vertical structures arranged in the warehouse. Storage racks typically comprise vertical uprights to which pairs of brackets are secured in order to support receptacles. The two brackets of the pair, arranged in a cantilevered manner relative to the uprights, are oriented towards each other and configured to support one of the receptacles. The pairs of brackets thus define cells along the height of the rack, each cell being adapted to accommodate one of the receptacles containing one or more items to be stored within the warehouse.

Said receptacle generally consists of a bin or tray, typically made of plastic, generally of parallelepipedal shape with a rectangular base, and capable of storing said item(s) in question. These receptacles are received in the cells by resting on the brackets of the storage racks.

Each autonomous vehicle is able to travel around the warehouse to collect receptacles housed in the cells of the storage racks. Autonomous vehicles are known that move along the floor and are adapted to climb vertically along the vertical uprights of the storage racks in order to collect receptacles housed in a cell at a high location.

However, it has been observed that the vertical movement of autonomous vehicles along the storage racks generates vibrations, causing displacement of the receptacles along the brackets. The receptacles may then protrude from the cells, to the point of falling or ending up in the path of the autonomous vehicles. In the latter scenario, the autonomous vehicle collides with the receptacle during its vertical movement, often resulting in damage to the vehicle and/or receptacle, which can completely immobilize the autonomous vehicle in the racks. A receptacle displacement of a few millimeters is sufficient to cause collisions. A fallen receptacle or this type of damage requires maintenance that interferes with the operation of the ASRS, in that the system must be interrupted and production stopped. This therefore represents a net loss for the end user of the system.

It has been proposed to have specific autonomous vehicles within the ASRS that differ from the fleet of autonomous vehicles because their mission is not to collect receptacles, but simply to push back and precisely reposition the receptacles in the cells of the storage racks, when the receptacles are protruding from said cells.

Such dedicated autonomous vehicles travel the same routes as the fleet of autonomous vehicles within the warehouse, thus contributing to warehouse congestion. It may then become necessary to reduce the number of autonomous vehicles that are circulating for receptacle collection. The efficiency of the ASRS may be significantly reduced.

In addition, it is necessary to identify the receptacles protruding from the racks in order to guide the dedicated autonomous vehicles to those specific receptacles. In this case, the ASRS must include means for locating displaced receptacles, as well as means for directing the dedicated vehicles to the displaced receptacles. The complexity and costs associated with implementing and using the ASRS are increased.

Furthermore, there is a delay between the detection of a displaced receptacle and the visit of the dedicated vehicle to replace the receptacle. Correction is not immediate. As a result, autonomous vehicles cannot move along the rack where there is a displaced receptacle, at the risk of colliding with it. Here again, the efficiency of the ASRS is reduced.

### SUMMARY

This disclosure aims in particular to provide a simple, economical, and effective solution to the problems mentioned above.

An autonomous vehicle for an item storage and retrieval system (ASRS) is proposed, the autonomous vehicle being configured to move about in a storage area in order to collect a receptacle among a plurality of receptacles stored in the storage area, each receptacle being arranged inside a cell of the storage area, the cells being distributed along two horizontal directions and in a vertical direction, the autonomous vehicle comprising:
a chassis;
gripping means capable of gripping the receptacle;
rolling means adapted to move the chassis in the two horizontal directions;
climbing means adapted to move the chassis in the vertical direction;
at least one deflector mounted laterally on the chassis, the deflector having an external guide surface that is inclined relative to the vertical direction and configured to push the receptacles towards a back of the cells when the chassis is moved in the vertical direction.

The deflector is thus an integral part of the autonomous vehicle used for collecting receptacles. The storage area footprint can be reduced compared to a situation where some vehicles circulate to retrieve receptacles and others circulate to reposition the displaced bins.

When the autonomous vehicle passes in front of cells in order to retrieve a receptacle, the deflector is able to push back displaced receptacles automatically, without stopping or requiring any particular action on the part of the autonomous vehicle. In addition to the fact that the autonomous vehicle does not need to know the positioning of the displaced receptacles and does not need to avoid them, the choice of specific characteristics for the deflector allows immediate and extremely precise repositioning of the receptacles that had been out of place.

In general, the deflector is advantageously configured to ensure the movement of the receptacles towards the back of the cells during the vertical movement of the vehicle, by means of the work of the guide surface of the deflector which is then fixed relative to the vehicle chassis. Advantageously, such an operation does not in itself require a movement of the deflector relative to the chassis during this work, and therefore no use of an actuator for such movement.

The features set forth in the following paragraphs may optionally be implemented, independently of each other or in combination with each other.

The chassis may carry internal components comprising at least one set of control electronics, one or more drive units for the rolling means, and an autonomous source of electrical energy, said chassis comprising a casing comprising one or more shells, covering the chassis while at least partially hiding the internal components, and wherein said at least one deflector is the shell or at least one of the shells of the casing, covering a side of the chassis, extending in the vertical direction while protruding outwardly from the chassis.

The deflector is thus a part of simple construction that combines a dual function, namely:
a primary function as a guide element, configured to push back the receptacle during the vertical movement of the vehicle,
a function as a casing element for one or more sides of the chassis, configured to hide the internal components.

The geometry of the deflector itself makes it possible to reposition the receptacles in the cells. The deflector does not require adding an additional part to the casing. Consequently, the complexity of the autonomous vehicle is not increased by adding the deflector.

Furthermore, the deflector may be integrated into the autonomous vehicle in a simple manner, by modifying an existing exterior part of the autonomous vehicle. There are no new components, only a simple modification of the shape and dimensions of the casing. Integration of the deflector may be carried out by using already-existing fastening means on the chassis of the autonomous vehicle.

In one variant, said at least one deflector is different from the shell or shells of the casing. It is thus possible to separate the casing function, which can be provided by lightweight and potentially flexible elements (e.g. thermoformed plastic), from the deflector function, which can be provided by a rigid and strong part (e.g. metal), positioned locally at an appropriate location on the vehicle.

The guide surface may extend in the vertical direction and may comprise an inclined guide section configured to push the receptacles towards the back of the cells during an ascent in the vertical direction.

The autonomous vehicle typically ascends to position itself vertically at the level of a receptacle to be retrieved, and loads itself with the receptacle to be retrieved before descending with the receptacle. By pushing receptacles back during the ascent of the autonomous vehicle, any risk of collision between the autonomous vehicle and displaced receptacles is avoided.

The inclined guide section, configured to push receptacles towards the back of the cells during an ascent in the vertical direction, may extend between a first point arranged at an upper end of the deflector and a second point arranged between the upper end and a lower end of the deflector; the straight line connecting the first and second points may form an angle of between 5° and 20° with a vertical axis extending in the vertical direction.

Due to the specific angle at the upper part of the guide section, incorrect repositioning of the receptacles or the receptacles being bounced back by an abutment provided at the back of the cells is avoided.

A distance measured in the vertical direction between the first point and the second point may be between 60 mm and 100 mm.

The guide section protrudes from the chassis by a distance which allows pushing back those receptacles which protrude from the cells by only a few millimeters (for example 10 mm), without interfering with the climbing members along which the autonomous vehicle climbs, or with the uprights of the storage racks.

The guide surface may comprise:
said inclined guide section, configured to push the receptacles towards the back of the cells during an ascent in the vertical direction, which is a first guide section; and
a second inclined guide section, arranged below the first section in the vertical direction, configured to push towards the back of the cells during a descent of the vehicle in the vertical direction.

The deflector is thus able to push back the displaced receptacles during the ascent of the autonomous vehicle in order to retrieve a receptacle, and also during the descent of the autonomous vehicle, without the autonomous vehicle having to stop or take any particular action.

There may be a risk that the receptacle will have been displaced again after its repositioning during the ascent of the autonomous vehicle. Such movement may be caused by its bouncing against the back of the cells, generated by an exaggerated thrust on the receptacle by the (first) guide section of the deflector during the ascent, but even more so by the vibrations caused by the movement of another autonomous vehicle located nearby the receptacle. The movement may cause the receptacle to unintentionally protrude once again, while the autonomous vehicle is moving about vertically along the vertical direction above the receptacle. The second guide section of the deflector then makes it possible to avoid a collision during the descent, by pushing the receptacle towards the back of the cell during the descent of the vehicle.

The second inclined guide section may extend between a third point, possibly coincident with the second point, and a fourth point arranged at the lower end of the deflector, the straight line connecting the third and fourth points forming an angle of between 5° and 20° with the vertical direction.

Due to the specific angle at the lower part of the guide section, incorrect repositioning of the receptacles is avoided, and, moreover, it allows pushing back a protruding receptacle displaced by vibrations related to the movement of an autonomous vehicle traveling near the receptacle or by bouncing back from an abutment provided at the back of the cells.

A distance measured in the vertical direction between the third point and the fourth point is between 60 and 100 mm.

The cumulative height of the first and second guide sections corresponds to the height of a standard casing without guide sections. It is thus possible to mount the shell to the chassis without modifying the chassis, using already-existing fastening means.

The shell may be a thin-walled plastic structure; preferably the shell is made of polycarbonate. Alternatively, the shell may be a thin-walled metal structure, for example made of aluminum.

The shell is thus easily produced at low cost. However, the shell has mechanical properties, in particular rigidity, suitable for pushing back receptacles having a mass between 1.5 kg and 30 kg, without breaking.

The autonomous vehicle may comprise two deflectors mounted on two opposite sides of the chassis.

The autonomous vehicle may ascend by engaging with climbing members provided on two storage racks which face each other. By providing deflectors which each face one of the two storage racks, it is possible to push back the displaced receptacles of the cells of these two storage racks.

The climbing means may comprise:
at least one motorized toothed wheel, preferably two toothed wheels, arranged laterally on the chassis on the same side as the deflector, said at least one toothed wheel being configured to mesh with a climbing member comprising a gear-rack or a link chain extending in the vertical direction,
a deployment mechanism configured to deploy and retract said at least one toothed wheel relative to the chassis, said at least one toothed wheel transitioning from a retracted position intended for decoupling the wheel from the gear-rack at the climbing member, to a deployed position configured for coupling said toothed wheel to said climbing member,
   and wherein said deployment mechanism is configured to deploy and retract the deflector in conjunction with the deployment and retraction of said at least one toothed wheel.

The width of the autonomous vehicle in the retracted position is less than the space between the storage racks, which forms aisles such that the autonomous vehicle can travel freely between the racks. Deploying the deflector and the toothed wheel allows the climbing means and the deflector to be brought closer to the storage racks, respectively in order to climb and to push back the bins.

The rolling means may comprise at least one wheel, adapted to move the chassis, and means for changing the direction, adapted to change the orientation of the wheel.

The autonomous vehicle may move over the floor without requiring guidance means such as rails (free-field movement). The autonomous vehicle can thus easily navigate within the warehouse and circulate even if the arrangement of the storage racks is modified. The autonomous vehicle is versatile. The vehicles are flexible, and it is possible to rearrange the storage racks easily and without interrupting production, in order to adapt to requirements (in the event of a decrease in activity, for example).

According to another aspect, an item storage and retrieval system is provided, comprising:
a plurality of storage racks arranged in a storage area along two horizontal directions, each rack extending in a vertical direction, the storage racks comprising:
   cells along the vertical direction, the cells having loading and unloading openings for loading/unloading receptacles in a horizontal loading and unloading direction, and
   vertical climbing members,
a plurality of receptacles arranged in the cells of each storage rack,
at least one autonomous vehicle comprising climbing means configured for coupling to the climbing members to ensure the vertical movement of the chassis, and wherein said at least one deflector is facing the loading or unloading openings of the cells of the storage rack when the chassis is moving along the vertical direction, said at least one deflector being interposed between the loading openings of the storage rack and the chassis of the vehicle.

In a nominal position of the receptacle in the cell, a distance between a back end of the receptacle and the back of the cell may be between 8 and 12 mm, and the autonomous vehicle may be configured to return the receptacle to the nominal position when the receptacle has been displaced by 10 mm or more from the nominal position.

Each receptacle may be adapted to receive at least one item, the receptacle and the at least one item having a mass between 1.5 kg and 30 kg. The geometry of the deflector is adapted to precisely reposition receptacles having such a load.

According to yet another aspect, a method for retrieving a receptacle is provided, implemented in an item storage and retrieval system:
associating the autonomous vehicle with a receptacle to be retrieved in the storage area;
moving the autonomous vehicle in the two horizontal directions until the autonomous vehicle is aligned with vertical climbing members of one of the storage racks receiving the receptacle to be retrieved;
coupling the vehicle's climbing means to the climbing members of the storage rack;
moving the autonomous vehicle in the vertical direction until the autonomous vehicle is vertically positioned at the level of the receptacle to be retrieved, and, during the movement of the vehicle in the vertical direction, pushing towards the back of the cells the receptacles which are protruding from the cells, by contact between the receptacles and the deflector of the autonomous vehicle.

The autonomous vehicle may move in the vertical direction at a speed of between 0 m/s and 3 m/s. Such speeds allow correctly repositioning the receptacles in the cells.

### BRIEF DESCRIPTION OF DRAWINGS

Other features, details and advantages will become apparent from reading the detailed description below, and from analyzing the attached drawings, in which:

FIG. 1 is a schematic view of an item storage and retrieval system.

FIG. 2 is a schematic view of details of a storage rack of the item storage and retrieval system of FIG. 1.

FIG. 3 is a schematic perspective view of an autonomous vehicle that may be utilized in the item storage and retrieval system of FIG. 1.

FIG. 4 is a schematic perspective view of a shell of a casing that may be utilized in the autonomous vehicle of FIG. 3.

FIG. 5 is a cross-section of FIG. 4.

FIG. 6 represents a functional diagram of a method for retrieving an item, implemented in the item storage and retrieval system of FIG. 1.

FIG. 7

FIG. 7 is a schematic view of an example of the movement of an autonomous vehicle in the item storage and retrieval system of FIG. 1, in order to retrieve an item.

### DESCRIPTION OF EMBODIMENTS

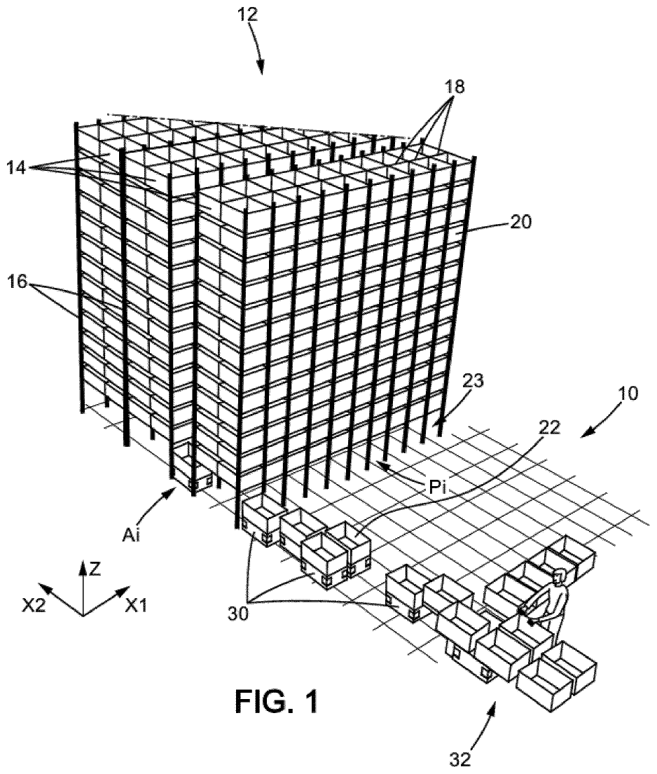

FIG. 1 schematically represents an automated storage and retrieval system ASRS 10 which comprises a storage area 12. In the remainder of the description, reference is made to a vertical direction Z, a first horizontal direction X1, and a second horizontal direction X2. It is understood that the vertical direction Z is perpendicular to the first horizontal direction X1 and to the second horizontal direction X2. In addition, the second horizontal direction X2 is perpendicular to the first horizontal direction X1

The storage area 12 comprises a plurality of storage racks 14. Each storage rack 14 is served by at least one aisle Ai extending in the first horizontal direction X1. Each storage rack 14 comprises several pairs of vertical uprights 16 arranged along the first horizontal direction X1. Each upright 16 extends in the vertical direction Z. The uprights 16 of each pair of uprights are spaced apart from each other in the second horizontal direction X2. Each storage rack 14 thus forms a plurality of columns 18 arranged one after the other in the first horizontal direction X1.

Each column 18 of the storage rack 14 comprises a plurality of cells 20, each adapted to contain a receptacle 22 which itself contains at least one item. The cells 20 of each column 18 are arranged between two successive pairs, in the first horizontal direction X1, of uprights 16. The cells 20 of each column 18 are superimposed as a plurality of levels in the vertical direction Z, between a bottom level and a top level.

The cell 20 of the bottom level is above the level of the floor. According to one embodiment, each column 18 may therefore comprise a free space 23 formed vertically between floor level and the cell 20 of the bottom level. According to one embodiment, the storage area 12 may thus comprise a plurality of passages Pi extending at floor level in the second horizontal direction X2, each passage Pi traversing the free space 24 of one of the columns 22 of each storage rack 20. These passages Pi allow the autonomous vehicles 30 to circulate under the storage racks 14, enabling the autonomous vehicles to access a given position directly in said at least one aisle Ai, and without requiring the vehicle to travel along said at least one aisle Ai.

According to another embodiment (not illustrated), the storage area 12 may be without any such passages (denoted Pi) under the storage rack 14. The movement of the autonomous vehicles to a given position in said at least one aisle Ai requires the vehicle to travel along said at least one aisle Ai from one of its ends.

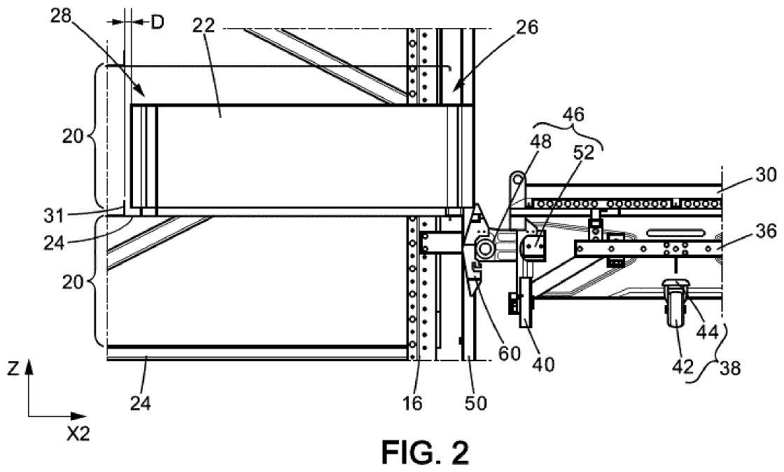

FIG. 2 illustrates a cell 20 of a storage rack 14, in more detail. Pairs of brackets 24 are secured to the pairs of uprights 16 of each column 18, separating the cells 20 from each other in the vertical direction Z. Each cell 20 is delimited beneath by two pairs of brackets 24 which are successive in the vertical direction Z. The receptacles 22 in the cells 20 rest on a pair of brackets 24. The two brackets of a pair of brackets 24 are affixed in a cantilevered manner to the uprights 16, oriented towards each other. Each pair of brackets is configured to support the receptacle 22 by two separate supports under the receptacle.

Each receptacle 22 is received in a loading opening 26 of the cell 20 so as to extend towards a back 28 of the cell 20. The loading opening 26 faces the aisle Ai serving the cell 20. The back 28 of the cell 20 is at a distance from the aisle Ai. In the illustrated example, each cell 20 may receive two receptacles 22, one behind the other along the second horizontal direction X2. In this example, the back 28 of the cell 22 corresponds to a central portion of the cell 20, between two neighboring aisles Ai. The back 28 of each cell 20 is, for example, delimited by an abutment means 31, integral to the brackets 24.

The receptacles 22 housed in the cells 20 are typically plastic bins or trays. The receptacles 22 are typically parallelepipedal in shape. The receptacles may contain one or more items, such that the total mass of the receptacle 22 and item(s) is between 1.5 kg and 30 kg.

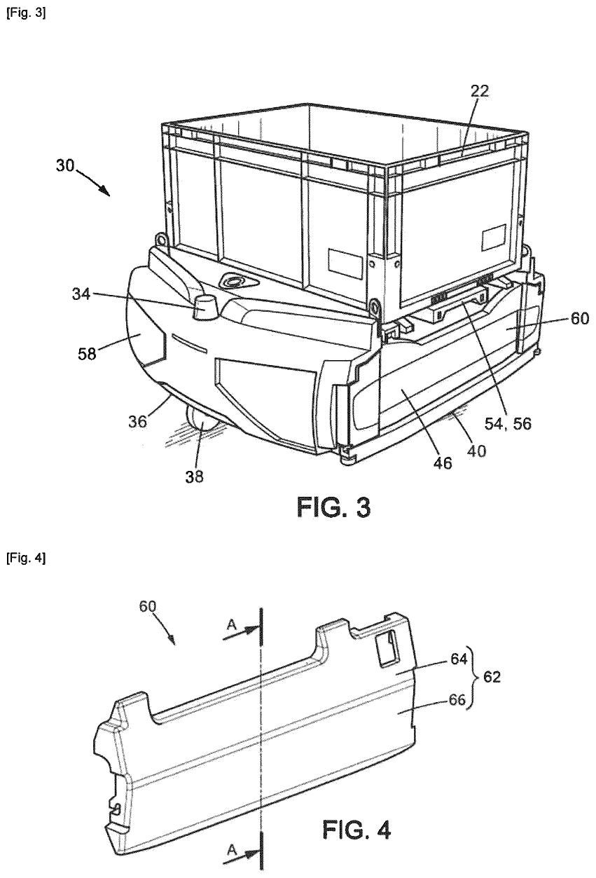

A fleet of autonomous vehicles 30 is responsible for transporting the receptacles 22 from the cells 20 to an order preparation station 32. An example of an autonomous vehicle 30 is illustrated in FIG. 3.

Here, each autonomous vehicle 30 is an automated guided vehicle or AGV. For this purpose, the autonomous vehicle 30 comprises control electronics (not illustrated). The control electronics can receive instructions for the receptacles 22 to be collected and can calculate a route between the position of the autonomous vehicle 30 and the position of the cell 20 containing the receptacle 22 to be collected. The autonomous vehicle 30 then comprises a guidance system 34, in this case laser guidance, to guide itself within the warehouse and collect the receptacle 22 in question. Alternatively, the guidance system 34 could comprise means for following floor markings. The storage area 12 then comprises floor markings forming guide lines. The floor markings may comprise, for example, rectilinear strips along the first horizontal direction X1 and rectilinear strips along the second horizontal direction X2.

To move over the floor in the two horizontal directions X1, X2, each autonomous vehicle 30 comprises a chassis 36, typically of parallelepipedal shape, and one or more rolling means 38. In the example illustrated, the autonomous vehicle 30 comprises two rolling means 38 arranged on a lower front side and a lower rear side of the chassis 36. In this case, the autonomous vehicle 30 may comprise two lateral rolling bearings 40 arranged on the two lower lateral sides, to ensure the isostatic equilibrium of the autonomous vehicle 30. Alternatively, the autonomous vehicle 30 may comprise four rolling means 38, each rolling means 38 being arranged at a lower corner of the chassis 36.

Each rolling means 38 comprises a wheel 42 having an axis of revolution that is perpendicular to the vertical direction and a fork 44 on which the wheel 42 is mounted so as to pivot about the axis of revolution. Drive means (not shown), in particular a set of pinions, make it possible to rotate the wheel 42 about its axis of revolution relative to the chassis 36. The autonomous vehicle 30 comprises an actuator connected to each drive means. Alternatively, each rolling means 38 may comprise a respective actuator for actuating the drive means.

Each rolling means 38 further comprises means for changing the direction of movement (not shown). These means for changing the direction of movement comprise pivoting means for pivoting the wheel 42 about a vertical axis relative to the chassis 36. Each rolling means 38 here comprises an actuator for actuating the pivoting means. Alternatively, a single actuator may be provided for actuating the pivoting means of each rolling means 38.

The rolling means 38 may be configured for free-field operation on a floor that has no guide rails, in particular along the two horizontal directions X1, X2. Such rolling means 38 allow for faster and more flexible installation of the item storage and retrieval system 10. In addition, the noise footprint is also reduced, for the comfort of human operators working in the warehouse.

To carry out movements in the vertical direction Z and to position itself vertically at the level of a cell 20 containing a receptacle 22 to be collected, each autonomous vehicle 30 comprises climbing means 46. The climbing means 46 comprise one or more toothed wheels 48, each configured to move the autonomous vehicle 30 along an upright 16 of the storage rack 14 by engaging with a climbing member 50 of the upright 16. Here, each storage rack 14 comprises a climbing member 50, in this case a gear-rack or a link chain extending vertically along each upright 16. The climbing member 50 is secured to the respective upright 16. When ascending or descending, a rotational movement of each toothed wheel 48 of the climbing means 46 is converted into a vertical movement of the autonomous vehicle 30 along the uprights 16.

The climbing means 46 comprise at least a first toothed wheel 48 capable of engaging with the climbing member 50 of one of the uprights 16 of a first storage rack 14 and a second toothed wheel 48 capable of engaging with the climbing member 50 of one of the uprights 16 of a second storage rack 14 that is adjacent to the first storage rack 14, the uprights 16 being in line with one another in the second horizontal direction X2.

In the current case, the climbing means 46 comprise four toothed wheels 48:
two toothed wheels 48 capable of engaging with two uprights 16 of a first storage rack 14, the two uprights 16 of the first storage rack 14 being consecutive in the first horizontal direction X1;
two toothed wheels 48 capable of engaging with two uprights 16 of a second storage rack 14 adjacent to the first storage rack 14 in the second horizontal direction X2, the two uprights 16 of the second storage rack 14 being consecutive in the first horizontal direction X1 and respectively facing one of the consecutive uprights of the first storage rack 14 in the second horizontal direction X2.

Each toothed wheel 48 of the climbing means 46 may be movable between a retracted position in which the toothed wheel 48 is housed in or above the chassis 36 and a deployed position in which the toothed wheel 48 protrudes laterally from the chassis 36. For this purpose, the climbing means 46 comprise a deployment mechanism 52 for deploying the toothed wheel(s) 48. In the retracted position, the autonomous vehicle 30 has a width which is less than a distance separating two consecutive pairs of uprights 16 in the second horizontal direction X2 or optionally in the first horizontal direction X1. The autonomous vehicle 30 may circulate freely in the aisles Ai extending in the first horizontal direction X1 or optionally through passages Pi (optional) extending in the second horizontal direction X2.

In order to load a receptacle 22 to be collected, onto the autonomous vehicle 30, the autonomous vehicle 30 comprises gripping means 54. The gripping means 54 comprise a retractable arm 56 adapted to be deployed into the cell 20 of the storage rack 14. The retractable arm 56 is deployable in the second horizontal direction X2 (here, the second horizontal direction X2 forms a loading/unloading direction). The retractable arm 56 is deployed into the loading opening 26 of the cells 20 which is facing the autonomous vehicle 30, towards the back 28 of the cells 20. An actuator allows deploying or retracting the deployable arm 56. The retractable arm 56 is adapted to extract the receptacle 22 from the cell 20 and load it onto an upper surface of the chassis 36.

Furthermore, the autonomous vehicle 30 is powered by an autonomous source of electrical energy (not illustrated). The energy source is a battery on board the chassis 36. The autonomous vehicle 30 may in particular recharge itself by connecting to a charging station arranged in the warehouse.

Each autonomous vehicle 30 comprises a casing 58 adapted to protect the components of the autonomous vehicle 30. The casing 58 extends in the vertical direction Z from the four sides of the chassis 36, to cover the internal components on board the chassis 36. The casing 58 here comprises a plurality of shells. In particular, there are movable side shells 60, mounted on the lateral sides of the chassis 36 on which are provided the climbing means 46. The deployment mechanism 52, when it moves the toothed wheel(s) 48, also moves the shells 60 of the casing 58. When the climbing means 46 are deployed, the shells 60 are also deployed so as to protrude laterally relative to the chassis 36.

Each side shell 60 forms a deflector 62 adapted to push the receptacles 22 protruding from the cells 20, towards the back of the cells 20. In a nominal position of each receptacle 22 in the cell 20, a distance D (measured along the second horizontal direction X2) separating a back end of the receptacle 22 and the back 28 of the cell 20 may be between 8 and 12 mm. When the receptacle 22 is displaced out of the nominal position along the second horizontal direction X2, the receptacle 22 may protrude from the loading opening 26 of the cells 20. This relative displacement between the receptacle and the brackets 24 may typically be caused by vibrations of the storage rack. The deployed deflector 62 is interposed between the chassis 36 and the loading openings 26 of the cells 20. A guide surface 64,66 of the deflector 62 comes into contact with the displaced receptacles 22, for example those displaced by a distance of more than 10 mm from the nominal position. The guide surface 64,66 is inclined relative to the vertical direction Z, to allow the receptacles 22 to be pushed towards the back of the cells 20 in order to return to their nominal position.

In an alternative configuration, the shell(s) are separate from the deflector.

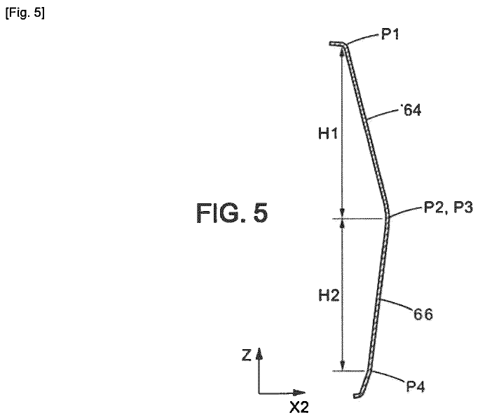

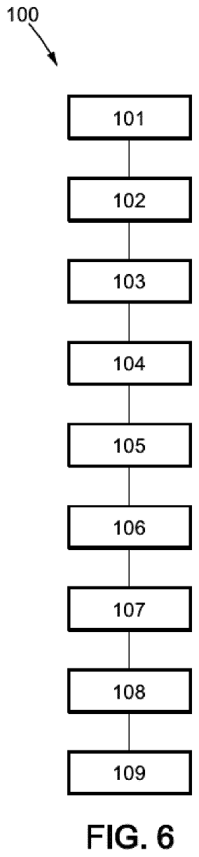

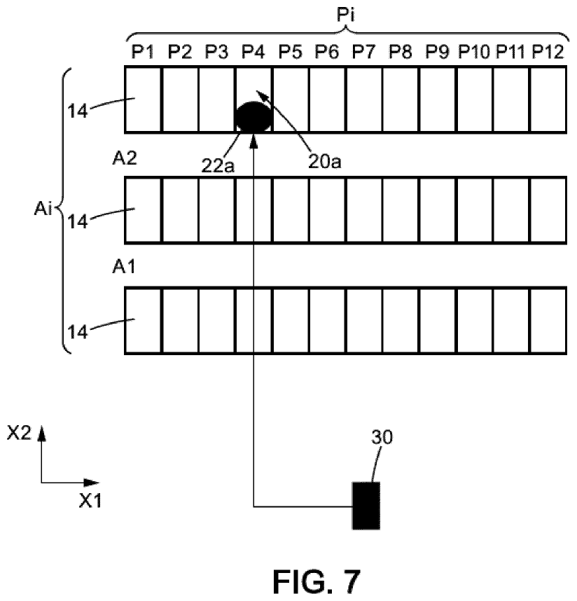

As is more visible in FIGS. 4 and 5, each side shell 60 comprises a first inclined guide section 64, an upper section. The first inclined guide section 64 extends from a first point P1 forming the upper end of the deflector 62 and a second point P2 below the first point P1 in the vertical direction Z. The straight line connecting the first and second points P1, P2 may form, with the vertical axis Z of the chassis 36, an angle 1 of between 5° and 20°. In addition, the height H1 of the first inclined guide section 64, measured in the vertical direction Z, may be between 60 and 100 mm. The first inclined guide section 64 forms a slope between the first and second points P1, P2, protruding laterally from the chassis 36. The slope allows guiding the receptacles 22 towards the nominal position during an ascent of the autonomous vehicle 30 along the vertical direction Z.

Each side shell 60 may here comprise a second inclined guide section 66, a lower section. The second guide section 66 extends from a third point P3 to a fourth point P4 forming the lower end of the side shell 60. Here, the second and third points P1, P3 are coincident. The second inclined guide section 66 extends as a continuity of the first inclined guide section 64 in the vertical direction Z. The straight line connecting the third and fourth points P3, P4 may form, with the vertical axis Z of the chassis 36, an angle a2 of between 5° and 20°. The height H2 of the second guide portion 66, measured in the vertical direction Z, may be between 60 mm and 100 mm. The second inclined guide section 66 forms a slope between the third and fourth points P3, P4, adapted to guide the receptacles 22 towards the nominal position during a descent of the autonomous vehicle 30 along the vertical direction Z.

Each side shell 60 is in particular a thin-walled plastic shell, for example formed by injection molding. Each side shell 60 may for example be made of polycarbonate. Alternatively, each side shell 60 could be a metal shell, for example made of aluminum. The thickness of each side shell 60 may be between 1 mm and 3 mm. The side shells 60 have sufficient rigidity to withstand impacts against the receptacles 22, in particular when the autonomous vehicle 30 is moving at a speed of up to 3 m/s in the vertical direction, and when the combined mass of the receptacles 22 and items is between 1.5 and 30 kg.

A method for retrieving a receptacle 100, implemented in the item storage and retrieval system 10 described above, is now described.

The method 100 comprises a first step 101. The first step 101 comprises associating an autonomous vehicle 30a located at an initial position in the warehouse with a receptacle to be collected 22a in the storage area 12. The receptacle to be collected 22a is arranged inside a collection cell 20a among the plurality of cells 20 of the storage area 12. The receptacle to be collected 22a comprises one or more items to be collected for order preparation.

The first step 101 may comprise a first subsidiary step of selecting the receptacle to be collected 22a in the storage area 12, which allows establishing the position of the collection cell 20a. The position of the collection cell 20a may be established as the aisle Ai serving the storage rack 14 in which the collection cell 20a is located, the column 18 of the storage rack 14 in which the collection cell 20a is located, and the level at which the collection cell 20a is located along the storage rack 14.

The first step 101 may comprise a second subsidiary step which comprises establishing communication with the autonomous vehicle 30a located in the initial position, for example by means of a wireless communication network such as WiFi; WiMAX, IWLAN, GSM, GPRS, UMTS (registered trademarks).

The method 100 comprises a second step 102. The second step 102 comprises sending instructions to the electronic control unit of the autonomous vehicle 30a. The instructions comprise the position of the collection cell 20a and instructions to calculate a route between the initial position of the autonomous vehicle 30a and the position of the collection cell 20a. The calculated route here comprises a movement of the autonomous vehicle 30 in the first horizontal direction X1 (or several movements in the first horizontal direction X1), and/or a movement in the second horizontal direction X2 (or several movements in the second horizontal direction X2). Also, the route is calculated based on the current and/or planned position of the other autonomous vehicles 30 provided in the warehouse. The path is established without allowing a collision with one of the other autonomous vehicles 30. For this purpose, provision may be made for sending to the control electronics, in real time, the current position of the other autonomous vehicles 30 of the fleet and/or their planned travel routes.

Alternatively, the second step 102 may be replaced by a calculation of the route between the initial position of the autonomous vehicle 30a and the position of the collection cell 20a by a central control unit located remotely from the autonomous vehicle 30a, and a sending of the route to the autonomous vehicle 30a.

The method 100 comprises a third step 103. The third step 103 comprises moving the autonomous vehicle 30a over the floor in the two horizontal directions X1, X2.

The third step 103 may comprise moving the autonomous vehicle 30a over the floor at least in the first horizontal direction X1 so as to align the autonomous vehicle 30a, in the second horizontal direction X2, with the passage Pi of the storage area 12 that leads to the column 18 in which the collection cell 20a is located.

The third step 103 may comprise a second subsidiary step which comprises moving the autonomous vehicle 30a over the floor in the second horizontal direction X2, within the passage Pi of the storage area 10 that leads to the column 18 in which the collection cell 20a is located.

The movements in the first and second horizontal directions X1, X2 may be repeated one or more times. At the end of the third step 103, the autonomous vehicle 30a is aligned with the climbing members 50 of the storage rack 14 forming the column 18 comprising the collection cell 20a.

The method 100 comprises a fourth step 104. The fourth step 104 comprises coupling the climbing means 46 of the autonomous vehicle 30a to the climbing members 50 of the storage rack 14 comprising the collection cell 20a.

The fourth step 104 may comprise a subsidiary step of deploying the climbing means 46. Here, each toothed wheel 48 of the climbing means 46 is deployed from the retracted position to the deployed position in order to be coupled to the gear-rack or link chain forming the climbing member 50. In this case, the deflector 62 is deployed along with each toothed wheel 48.

The method 100 comprises a fifth step 105. The fifth step 105 comprises moving the autonomous vehicle 30a in the vertical direction Z. The autonomous vehicle 30a moves along the upright 16 of the storage rack 14 by the engagement between the climbing means 46 of the autonomous vehicle 30a and the climbing members 50 of the storage racks 14, in this case via the rotation of each toothed wheel 48 and the gear-rack or link chain to which the toothed wheel 48 is coupled. The movement along the vertical direction Z is performed so as to vertically align the autonomous vehicle 30a with the level of the collection cell 20a containing the receptacle to be collected 22a.

During the fifth step 105 of moving the autonomous vehicle 30a in the vertical direction Z, the deflector 62 pushes back the receptacles 20 protruding from the storage cells 22. The guide surface of the deflector 62 comes into contact with the receptacles, repositioning them into their nominal position in the cells 20.

The method 100 comprises a sixth step 106. The sixth step 106 comprises loading the receptacle to be collected 22a, being held in the collection cell 20a, onto the upper surface of the chassis 36. The gripping means 54 are deployed into the collection cell 20a in order to grasp the receptacle to be collected 22a and position it on the upper surface.

The method comprises a seventh step 107. The seventh step 107 comprises moving the autonomous vehicle 30a in the vertical direction Z until the autonomous vehicle 30a is at floor level. As in the fourth step 104, the autonomous vehicle 30a moves by the engagement between the climbing means 46 of the autonomous vehicle 30a and the climbing members 50 of the storage racks 14.

Here again, during the seventh step 107 of moving the autonomous vehicle 30a in the vertical direction Z, the deflector 62 pushes back the receptacles 22 that are protruding from the storage cells 20.

The method 100 comprises an eighth step 108. The eighth step 108 comprises decoupling the climbing means 46 and the climbing members 50.

The eighth step 108 may comprise a subsidiary step of folding each toothed wheel 48 of the climbing means 46 towards the chassis 36. Each toothed wheel 48 of the climbing means 46 is folded from the deployed position to the folded position. The folding of each toothed wheel 48 also ensures the folding of the deflector 62 towards the chassis 36.

The method 100 comprises a ninth step 109. The ninth step 109 comprises moving the autonomous vehicle 30a over the floor in the first horizontal direction X1 and in the second horizontal direction X2, until the autonomous vehicle reaches the order preparation station 32.

The ninth step 109 may comprise a first subsidiary step which comprises moving the autonomous vehicle 30a over the floor in the second horizontal direction X2 within the passage Pi of the storage area 10, in order to exit the storage area 12.

The ninth step 109 may comprise a second subsidiary step of moving the autonomous vehicle 30a in the first horizontal direction X1 and/or in the second horizontal direction so as to access the order preparation station 32.

1. An autonomous vehicle (30) for an item storage and retrieval system (ASRS) (10), the autonomous vehicle (30) being configured to move about in a storage area (12) in order to collect a receptacle (22a) among a plurality of receptacles (22) stored in the storage area (12), each receptacle (22) being arranged inside a cell (20) of the storage area (12), the cells (20) being distributed along two horizontal directions (X1, X2) and in a vertical direction (Z), the autonomous vehicle (30) comprising:
a chassis (36);
rolling means (38) adapted to move the chassis (36) in the two horizontal directions (X1, X2);
climbing means (46) adapted to move the chassis (36) in the vertical direction (Z)
gripping means (54) capable of gripping the receptacle (22a);
at least one deflector (62) mounted laterally on the chassis (36), the deflector (62) having an external guide surface (64,66) that is inclined relative to the vertical direction (Z) and is configured to push the receptacles (22) towards a back (28) of the cells (20) when the chassis (36) is moved in the vertical direction (Z).

2. The autonomous vehicle (30) according to claim 1, wherein the chassis (36) carries internal components comprising at least one set of control electronics, one or more actuators for the rolling means, and an autonomous source of electrical energy, said chassis (36) comprising a casing (58) comprising one or more shells, covering the chassis (36) while at least partially hiding the internal components, and wherein said at least one deflector (62) is the shell or at least one of the shells of the casing, covering a side of the chassis (36), extending in the vertical direction (Z) while protruding outwardly from the chassis (36).

3. The autonomous vehicle (30) according to claim 1, wherein the chassis (36) carries internal components comprising at least one control electronics, one or more actuators for the rolling means, and an autonomous source of electrical energy, said chassis (36) comprising a casing (58) comprising one or more shells, covering the chassis (36) while at least partially hiding the internal components, and wherein said at least one deflector (62) is different from the shell or shells of the casing.

4. The autonomous vehicle (30) according to claim 1, wherein the guide surface (62) extends in the vertical direction (Z) and comprises an inclined guide section (64,66) configured to push the receptacles (22) towards the back (28) of the cells (20) during an ascent in the vertical direction (Z).

5. The autonomous vehicle according to claim 4, wherein the inclined guide section (64,66), configured to push the receptacles (22) towards the back (28) of the cells (20) during an ascent in the vertical direction (Z), extends between a first point (P1) arranged at an upper end of the deflector (62) and a second point (P2) arranged between the upper end and a lower end of the deflector (62), the straight line connecting the first and second points (P1, P2) forming an angle (a1) of between 5° and 20° with a vertical axis extending in the vertical direction (Z).

6. The autonomous vehicle (30) according to claim 5, wherein a height (H1) measured in the vertical direction (Z) between the first point and the second point (P1, P2) is between 60 mm and 100 mm.

7. The autonomous vehicle (30) according to claim 4, wherein the guide surface (60) comprises:
said inclined guide section (64), configured to push the receptacles (22) towards the back (28) of the cells (20) during an ascent in the vertical direction, which is a first guide section (64); and
a second inclined guide section (66), arranged below the first guide section (64) in the vertical direction (Z), configured to push the receptacles (20) towards the back (28) of the cells (20) during a descent of the autonomous vehicle (30) in the vertical direction (Z).

8. The autonomous vehicle (30) according to claim 7, wherein the second inclined guide section (66) extends between a third point (P3), possibly coincident with the second point (P2), and a fourth point (P4) arranged at the lower end of the deflector (62), the straight line connecting the third and fourth points (P3, P4) forming an angle of between 5° and 20° with the vertical direction (Z).

9. The autonomous vehicle (30) according to claim 8, wherein a height (H2) measured in the vertical direction (Z) between the third point and the fourth point (P3, P4) is between 60 mm and 100 mm.

10. The autonomous vehicle (30) according to claim 2, wherein the shell (60) is a thin-walled plastic or metal structure.

11. The autonomous vehicle (30) according to claim 1, wherein the autonomous vehicle (30) comprises two deflectors (62) mounted on two opposite sides of the chassis (36).

12. The autonomous vehicle (30) according to claim 1, wherein the climbing means (46) comprise:
at least one motorized toothed wheel (48), preferably two toothed wheels (48), arranged laterally on the chassis (36) on the same side as the deflector (62), said at least one toothed wheel (48) being configured to mesh with a climbing member (50) comprising a gear-rack or a link chain extending in the vertical direction (Z),
a deployment mechanism (52) configured to deploy and retract said at least one toothed wheel (48) relative to the chassis (36), said at least one toothed wheel (48) transitioning from a retracted position intended for decoupling the toothed wheel (48) from the climbing member (50), to a deployed position configured for coupling said toothed wheel (48) to said climbing member (50), and wherein said deployment mechanism (52) is configured to deploy and retract the deflector (62) in conjunction with the deployment and retraction of said at least one toothed wheel (48).

13. The autonomous vehicle (30) according to claim 1, wherein the rolling means (38) comprise at least one wheel (42), adapted to move the chassis (36), and means for changing the direction, adapted to change the orientation of the wheel (42).

14. An item storage and retrieval system (10) comprising:
a plurality of storage racks (14) arranged in a storage area (12) along two horizontal directions (X1, X2), each storage rack (14) extending in a vertical direction (Z), the storage racks (14) comprising:
a plurality of cells (20) along the vertical direction (Z), the cells (20) having loading or unloading openings (26) for loading/unloading receptacles (22) in a horizontal loading and unloading direction (X2), and
vertical climbing members (50),
a plurality of receptacles (22) arranged in the cells (20) of each storage rack (14),
at least one autonomous vehicle (30) according to claim 1, comprising the climbing means (46) configured for coupling to the climbing members (50) in order to ensure the vertical movement of the chassis (36), wherein said at least one deflector (62) is facing the loading or unloading openings (26) of the cells (20) of the storage rack (14) when the chassis (36) is moving along the vertical direction (Z), said at least one deflector (62) being interposed between the loading openings (26) of the storage rack (14) and the chassis (36) of the autonomous vehicle (30).

15. The system according to claim 14, wherein, in a nominal position of the receptacle (22) in the cell (20), a distance (D) between a back end of the receptacle (22) and the back (28) of the cell (20) is between 8 and 12 mm, and the autonomous vehicle (30) is configured to return the receptacle (22) to the nominal position when the receptacle has been displaced by 10 mm or more from the nominal position.

16. The system according to claim 14, wherein each receptacle (22) is adapted to receive at least one item, the receptacle (22) and the at least one item having a mass between 1.5 kg and 30 kg.

17. A method for retrieving a receptacle (22), implemented in an item storage and retrieval system (10) according claim 14, comprising:
associating an autonomous vehicle (30a), among the at least one autonomous vehicle (30), with a receptacle to be retrieved (22a) in the storage area (12);
moving the autonomous vehicle (30a) in the two horizontal directions (X1; X2) until the autonomous vehicle (30a) is aligned with vertical climbing members (50) of one of the storage racks (14) receiving the receptacle to be retrieved (22a);
coupling the climbing means (46) of the autonomous vehicle (30a) to the climbing members (50) of the storage rack (14);
moving the autonomous vehicle (30a) in the vertical direction (Z) until the autonomous vehicle (30a) is vertically positioned at the level of the receptacle to be retrieved (22a), and, during the movement of the autonomous vehicle (30a) in the vertical direction (Z), pushing towards the back (28) of the cells (20) the receptacles (22) which are protruding from the cells (20), by contact between the receptacles (22) and the deflector (62) of the autonomous vehicle (30).

18. The method according to claim 17, wherein the autonomous vehicle (30) moves in the vertical direction at a speed of between 0 m/s and 3 m/s.
